(19) United States
(12) Patent Application Publication
(10) Pub. No.: US 2011/0083444 A1
(43) Pub. Date: Apr. 14, 2011

(54) LOW BTU FUEL INJECTION SYSTEM

(75) Inventors: Mahesh Bathina, Bangalore (IN); Ramanand Singh, Bangalore (IN); Gunnar Leif Siden, Greenville, SC (US); Andrew Mitchell Rodwell, Greenville, SC (US); Robert Thomas Thatcher, Greenville, SC (US)

(73) Assignee: GENERAL ELECTRIC COMPANY, Schenectady, NY (US)

(21) Appl. No.: 12/576,865

(22) Filed: Oct. 9, 2009

(51) Int. Cl. F02C 7/26; F02G 3/00; F01D 5/14

(52) U.S. Cl. 60/776; 60/39.12; 415/115

(57) ABSTRACT

A system includes a gas turbine compressor including multiple radial protrusions disposed about a circumference of the gas turbine compressor. Each radial protrusion includes multiple gaseous fuel injection orifices configured to inject gaseous fuel into the gas turbine compressor.

### BACKGROUND OF THE INVENTION

The subject matter disclosed herein relates to a low BTU fuel injection system.

Gas turbine engines combust a mixture of fuel and air to produce hot combustion gases. Gas turbine engines typically use a high British Thermal Unit (BTU) fuel such as natural gas. Low BTU fuels are often available at a low cost, yet these fuels are not easily workable in gas turbine engines. The low energy per volume can create problems with combustion, emissions, and performance of the gas turbine engines.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine compressor including an upstream stage and a downstream stage. The system also includes a gaseous fuel recirculation assembly in fluid communication with the upstream stage and the downstream stage. The gaseous fuel recirculation assembly is configured to inject gaseous fuel into the upstream stage, extract a fuel/air mixture from the downstream stage, and reinject the fuel/air mixture into the upstream stage.

In a second embodiment, a system includes a gas turbine compressor including multiple radial protrusions disposed about a circumference of the gas turbine compressor. Each radial protrusion includes multiple gaseous fuel injection orifices configured to inject gaseous fuel into the gas turbine compressor.

In a third embodiment, a system includes a gas turbine compressor including an air inlet disposed at an upstream end of the gas turbine compressor. The system also includes multiple gaseous fuel injection orifices disposed within the gas turbine compressor downstream from the air inlet. Each gaseous fuel injection orifice is configured to inject gaseous fuel into the gas turbine compressor.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a turbine system that injects a low BTU fuel into a gas turbine compressor in accordance with certain embodiments of the present technique;

FIG. 2 is a cutaway side view of the turbine system, as shown in FIG. 1, in accordance with certain embodiments of the present technique;

FIG. 3 is a cutaway side view of a compressor section, taken within line 3-3 of FIG. 2, illustrating a gaseous fuel recirculation assembly in accordance with certain embodiments of the present technique;

FIG. 4 is a cutaway side view of the compressor section, taken within line 3-3 of FIG. 2, illustrating gaseous fuel injection through a compressor casing and a compressor hub in accordance with certain embodiments of the present technique;

FIG. 5 is a cutaway side view of the compressor casing, taken within line 5-5 of FIG. 4, in accordance with certain embodiments of the present technique;

FIG. 6 is a cutaway side view of the compressor section, taken within line 3-3 of FIG. 2, illustrating gaseous fuel injection through stationary compressor vanes in accordance with certain embodiments of the present technique;

FIG. 7 is a perspective view of an exemplary stationary compressor vane including multiple gaseous fuel injection orifices in accordance with certain embodiments of the present technique;

FIG. 8 is a cutaway side view of the compressor section, taken within line 3-3 of FIG. 2, illustrating gaseous fuel injection through rotating compressor blades in accordance with certain embodiments of the present technique; and

FIG. 9 is a perspective view of an exemplary rotating compressor blade including multiple gaseous fuel injection orifices in accordance with certain embodiments of the present technique.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, the disclosed embodiments compress a low BTU fuel at least partially through a gas turbine compressor of a gas turbine engine. The use of the gas turbine compressor also may supplement a separate compressor configured to compress a portion of the low BTU fuel. In this manner, the use of the gas turbine compressor for low BTU fuel compression may substantially reduce or eliminate power utilized by the low BTU fuel compressor, thereby increasing the efficiency of the turbine system. Specifically, gaseous low BTU fuel may be injected into the gas turbine compressor. In such a configuration, the gas turbine compressor serves to compress and mix the fuel and air prior to injection into a combustor, thereby reducing or eliminating fuel injection directly into the combustor. Consequently, a smaller/less powerful fuel compressor may be utilized, and, in some cases, the fuel compressor may be omitted. As discussed in detail below, the gas turbine compressor includes certain features configured to enhance mixing of fuel and air, thereby increasing turbine system efficiency, reducing emissions of regulated exhaust products, and substantially reducing or eliminating the possibility of auto-ignition within the compressor. In one embodiment, the compressor includes a gaseous fuel recirculation assembly configured to inject fuel into an upstream stage of the gas turbine compressor. The recirculation assembly is also configured to extract a fuel/air mixture from a downstream compressor stage and reinject the mixture into the upstream stage. This configuration may increase mixing of the fuel and air within the compressor, further improving performance of the turbine system.

In further embodiments, the gas turbine compressor may include multiple radial protrusions disposed about a circumference of the gas turbine compressor. Each radial protrusion may include multiple gaseous fuel injection orifices configured to inject low BTU fuel into the compressor. In certain configurations, the radial protrusions are vanes or blades particularly configured to inject gaseous fuel into the compressor. In other embodiments, the compressor includes gaseous fuel injection orifices disposed downstream from an air inlet. Injecting fuel downstream from the inlet may facilitate enhanced mixing of fuel and air within the compressor due to the high-velocity multidirectional air flow pattern within the compressor. The increased mixing of fuel and air may improve turbine system efficiency compared to embodiments in which fuel is injected at the compressor inlet. In addition, because the enhanced mixing reduces the possibility of auto-ignition, additional fuel may be provided to the compressor, thereby substantially reducing or eliminating power utilized by the fuel compressor.

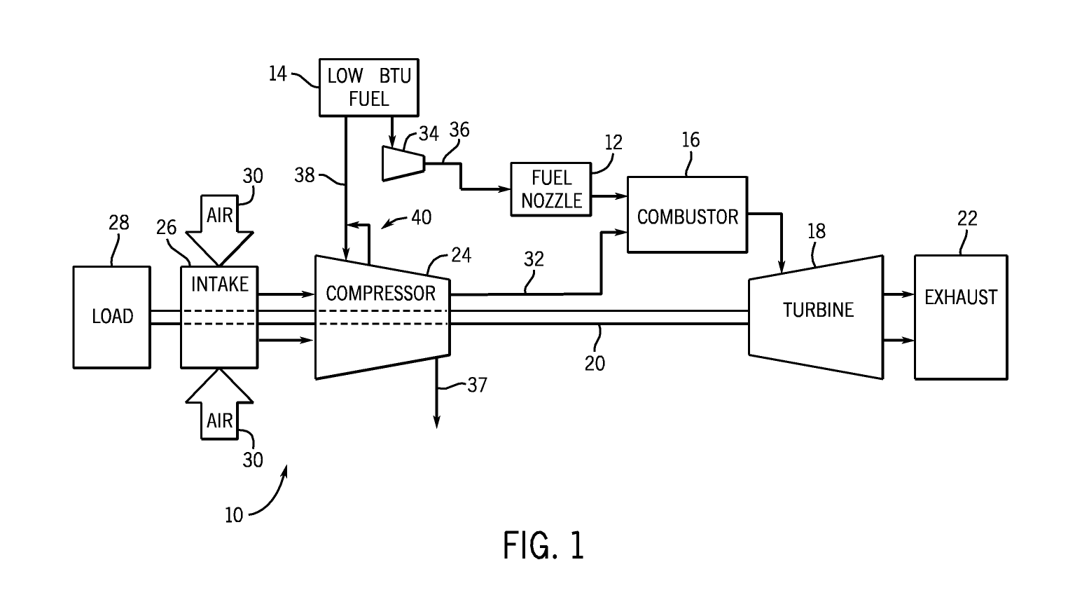

Turning now to the drawings and referring first to FIG. 1, a block diagram of an embodiment of a gas turbine system 10 is illustrated. The turbine system 10 includes a fuel nozzle 12, a low BTU fuel supply 14, and a combustor 16. As illustrated, the fuel supply 14 routes a low BTU fuel, such as coke oven gas (COG), blast furnace gas (BFG), gasified biomass (e.g., ethanol) or diluted high BTU fuel (e.g., natural gas diluted with air), to the turbine system 10 through the fuel nozzle 12 into the combustor 16. As will be appreciated, a heating value may be used to define energy characteristics of a fuel. For example, the heating value of a fuel may be defined as the amount of heat released by combusting a specified quantity of fuel. In particular, a lower heating value (LHV) may be defined as the amount of heat released by combusting a specified quantity of fuel (e.g., initially at 25° C. or another reference state) and returning the temperature of the combustion products to a target temperature (e.g., 150° C.). One exemplary unit of measure for LHV is British Thermal Units (BTU) per standard cubic foot (scf), e.g., BTU/scf. A standard cubic foot (scf) may be defined as a measure of quantity of gas, equal to a cubic foot of volume at 60 degrees Fahrenheit and either 14.696 pounds per square inch (1 atm) or 14.73 PSI (30 inHg) of pressure. In the following discussion, LHV and/or BTU levels (e.g., low or high) may be used to indicate the heating value of various fuels, but it is not intended to be limiting in any way. Any other value may be used to characterize the energy and/or heat output of fuels within the scope of the disclosed embodiments. In the present embodiment, the low BTU fuel may have a LHV of less than 25, 50, 100, 150, 200, 250, 300, 350, 400, 450, or 500 BTU/scf. By further example, the LHV of the low BTU fuel may be approximately between 25 to 500, 50 to 400, or about 75 to 350 BTU/scf. In alternative embodiments, the fuel supply may provide a high BTU fuel, such as natural gas, having a LHV of approximately between 600 to 1500, 700 to 1350, or about 800 to 1200 BTU/scf to the turbine system components described below.

As discussed below, the combustor 16 is configured to mix the fuel with compressed air. The combustor 16 ignites and combusts the fuel-air mixture, and then passes hot pressurized exhaust gas into a turbine 18. The exhaust gas passes through turbine blades in the turbine 18, thereby driving the turbine 18 to rotate. Coupling between blades in the turbine 18 and a shaft 20 will cause the rotation of the shaft 20, which is also coupled to several components throughout the turbine system 10, as illustrated. Eventually, the exhaust of the combustion process may exit the turbine system 10 via an exhaust outlet 22.

In an embodiment of the turbine system 10, compressor blades are included as components of a compressor 24. Blades within the compressor 24 may be coupled to the shaft 20, and will rotate as the shaft 20 is driven to rotate by the turbine 18. The compressor 24 may intake air to the turbine system 10 via an air intake 26. Further, the shaft 20 may be coupled to a load 28, which may be powered via rotation of the shaft 20. As will be appreciated, the load 28 may be any suitable device that may generate power via the rotational output of the turbine system 10, such as a power generation plant or an external mechanical load. For example, the load 28 may include an electrical generator, a propeller of an airplane, and so forth. The air intake 26 draws air 30 into the turbine system 10 via a suitable mechanism, such as a cold air intake. The air 30 then flows through blades of the compressor 24, which provides compressed air 32 to the combustor 16. In particular, the compressed air 32 and fuel 14 are injected directly into the combustor 16 for mixing and combustion.

As illustrated, the low BTU fuel 14 is routed to both the fuel nozzle 12 and the compressor 24. As will be appreciated, low BTU gaseous fuel may be compressed prior to injection into the combustor 16 to increase the energy density of the fuel, thereby enhancing the combustion process. Therefore, a fuel compressor 34 compresses the low BTU fuel 14 to provide a compressed fuel flow 36 to the fuel nozzle 12. Furthermore, uncompressed low BTU fuel 38 is fed directly into the compressor 24. As discussed in detail below, a pump may be provided to increase the pressure of the fuel flow 38 such that the fuel pressure is greater than the air pressure within the compressor 24.

The low BTU fuel may be injected into the compressor 24 through a compressor casing, a compressor hub, and/or radial protrusions such as stationary vanes or rotating blades. Furthermore, the low BTU fuel may be injected downstream from a compressor inlet. Such a configuration may facilitate enhanced mixing of fuel and air within the compressor 24 compared to configurations in which the low BTU fuel is injected at the compressor inlet. As discussed in detail below, the enhanced mixing may decrease the possibility of auto-ignition, thereby increasing the maximum allowable fuel concentration. Therefore, larger quantities of fuel may be injected through the compressor 24 while limiting the possibility of auto-ignition of the fuel/air mixture.

To further facilitate mixing, a gaseous fuel recirculation assembly 40 may be coupled to the compressor 24. This assembly 40 extracts a fuel/air mixture from a downstream compressor stage and reinjects the mixture into an upstream compressor stage. Such a system may provide increased mixing of the fuel and air, thereby further decreasing the possibility of auto-ignition and increasing the maximum allowable fuel flow into the compressor 24. As will be appreciated, injecting low BTU fuel into the compressor 24 may decrease or eliminate the quantity of fuel 36 provided by the compressor 34 to the fuel nozzle 12. For example, the present embodiment may employ a smaller/less powerful compressor 34 to compress the fuel prior to delivery to the fuel nozzle 12. As a result, less energy may be expended to drive the compressor 34, thereby increasing total power output of the turbine system 10. In certain embodiments, the compressor 34 may be reduced in size and/or power requirements by at least greater than approximately 10, 20, 30, 40, 50, 60, 70, 80, or 90 percent.

As will be appreciated, when operating the gas turbine system 10 on low BTU fuels, a pressure ratio may approach a limit for the compressor 24. For instance, the compressor pressure ratio (e.g., the ratio of the air pressure exiting the compressor 24 to the air pressure entering the compressor 24) may become lower than the pressure ratio across the turbine (e.g., the ratio of the hot gas pressure entering the turbine 18 to the hot gas pressure exiting the turbine 18). In order to provide the compressor 24 with pressure ratio protection (e.g., reduce the possibility of stalling the compressor 24), air discharged from the compressor 24 may be bled off via an overboard bleed air line 37.

The amount of air bled from the compressor 24 may be a function of ambient conditions and the gas turbine output. More specifically, the amount of air bled may increase with lower ambient temperatures and lower gas turbine loads. In addition, as described above, in gas turbine applications utilizing gaseous low BTU fuel 14, the flow rate of the fuel 14 will generally be much higher than in comparable natural gas fuel applications. This is primarily due to the fact that more low BTU fuel may be used in order to attain comparable heating or a desired firing temperature. As such, additional backpressure may be exerted on the compressor 24. In these applications, the air discharged from the compressor 24 may also be bled to reduce the backpressure and improve the stall margin (e.g., margin of design error for preventing stalling) of the compressor 24.

Bleeding compressed air discharged from the compressor 24 may decrease the net efficiency of the turbine system 10, because the energy expended to raise the pressure of the air within the compressor 24 is not recovered by the combustion chamber 16 and turbine 18. However, by injecting low BTU fuel 14 into the compressor 24, the present embodiment may substantially reduce or eliminate air extraction via line 37. Specifically, because the injected fuel 38 displaces a portion of the air within the compressor 24, less air is provided to the combustor 16. Consequently, a desired pressure ratio may be established within the compressor 24 without bleeding air or substantially reducing the quantity of bleed air. Because less air is extracted from the compressor 24 compared to configurations in which fuel is not injected into the compressor 24, the efficiency loss associated with air extraction may be substantially reduced or eliminated.

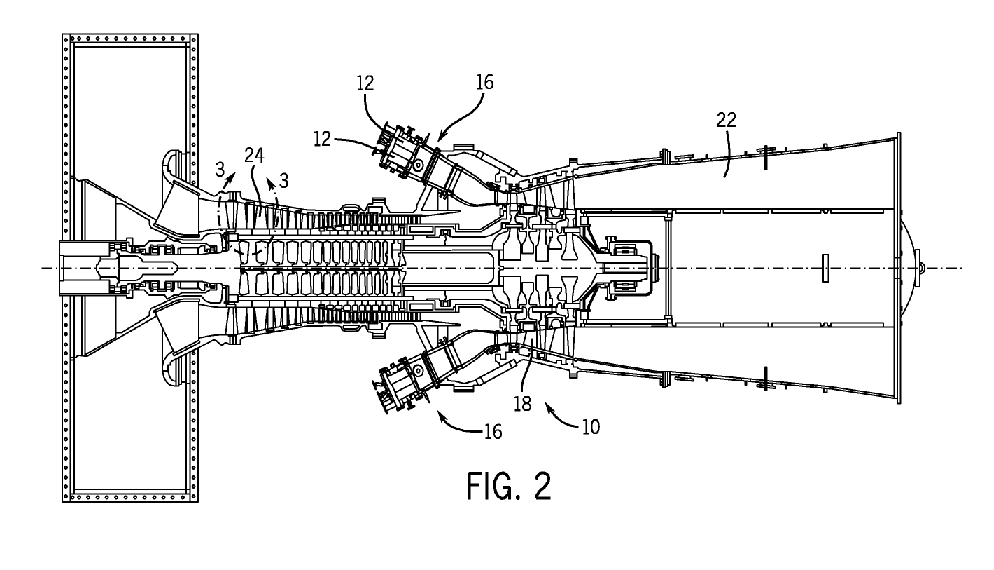

FIG. 2 shows a cutaway side view of an embodiment of the turbine system 10. As depicted, the embodiment includes the compressor 24, which is coupled to an annular array of combustors 16, e.g., six, eight, ten, or twelve combustors 16. Each combustor 16 includes at least one fuel nozzle 12 (e.g., 1, 2, 3, 4, 5, 6, 7, 8, 9, 10, or more), which feeds an air-fuel mixture to a combustion zone located within each combustor 16. Combustion of the air-fuel mixture within combustors 16 will cause vanes or blades within the turbine 18 to rotate as exhaust gas passes toward the exhaust outlet 22. As discussed in detail below, certain embodiments of the compressor 24 include a variety of unique features to facilitate enhanced mixing of air and fuel (e.g., low BTU fuel) within the compressor 24, thereby increasing efficiency of the turbine system 10, reducing emissions of regulated exhaust products, and substantially reducing or eliminating the possibility of auto-ignition within the compressor 24. Furthermore, the enhanced mixing may facilitate increased fuel flow into the compressor 24, thereby reducing the load on the fuel compressor 34 and decreasing the quantity of extracted air.

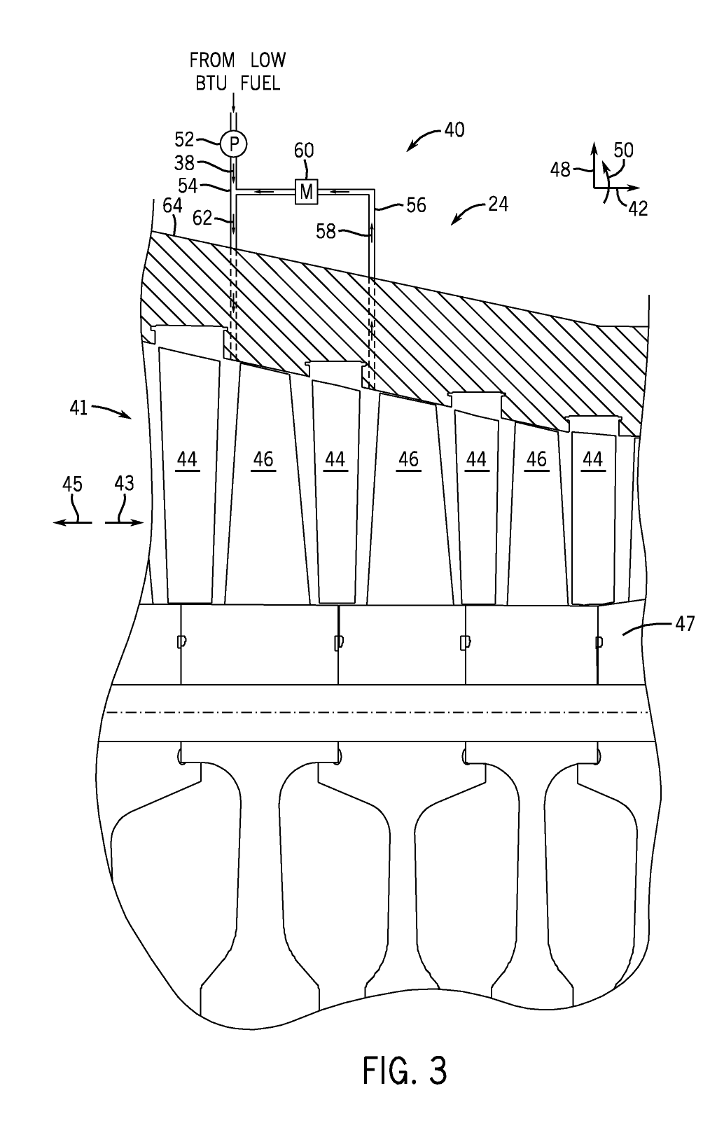

FIG. 3 is a detailed cross-sectional view of a portion of the compressor 24 taken within line 3-3 of FIG. 2. Air enters the compressor 24 through a compressor inlet 41 and flows in a downstream direction 43 along an axial direction 42. The air then passes through one or more compressor stages. The compressor 24 may include 1 to 25, 5 to 20, 10 to 20, or 14 to 18 compressor stages, for example. Each compressor stage includes vanes 44 and blades 46 extending outwardly from a hub 47 along a radial direction 48. In certain configurations, the vanes 44 and blades 46 are substantially equally spaced in a circumferential direction 50 about the compressor 24. The vanes 44 are rigidly mounted to the compressor 24 and are configured to direct air toward the blades 46. The blades 46 are driven to rotate by the shaft 20. As air passes through each compressor stage, air pressure increases, thereby providing the combustor 16 with sufficient air for proper combustion.

As previously discussed, a pump 52 is employed to deliver low BTU fuel 14 to the compressor 24. Specifically, the pump 52 increases the pressure of the gaseous low BTU fuel such that the output fuel pressure is greater than the air pressure within the compressor 24 at the point of injection. As will be appreciated, air pressure within the compressor 24 increases through each stage. Therefore, the pressure of a downstream stage (i.e., stage positioned along the downstream direction 43) is greater than the pressure of an upstream stage (i.e., stage positioned along the upstream direction 45). As illustrated, the gaseous low BTU fuel is injected within the first stage of the compressor 24. Therefore, the pump 52 may provide a pressure greater than the air pressure within the first stage. Similarly, if the gaseous low BTU fuel were delivered to a downstream stage, the pump 52 may provide a higher fuel pressure sufficient to inject fuel into the downstream stage. As will be appreciated, to reduce pump capacity, injection of fuel may be limited to upstream stages of the compressor 24 in certain embodiments.

The uncompressed low BTU fuel 38 flows through a conduit 54 from the pump 52 to the compressor 24. As illustrated, the present embodiment includes a gaseous fuel recirculation assembly 40 configured to extract a fuel/air mixture from a downstream compressor stage and inject the mixture into an upstream compressor stage. Specifically, a conduit 56 extends from a downstream compressor stage to the conduit 54. Because the low BTU fuel injected at the upstream stage mixes with air within the compressor 24, a fuel/air mixture 58 is present at the downstream compressor stage. The fuel/air mixture 58 flows through the conduit 56 into the fuel conduit 54, and mixes with the uncompressed low BTU fuel 38. In certain configurations, the gaseous fuel recirculation assembly 40 includes a mixing device 60 configured to further mix the fuel and air prior to reinjection into the compressor 24. As will be appreciated, the mixing device 60 may include various structures such as swirling vanes, tortuous paths, impinging flow arrangements, or other structures configured to mix the fuel and air.

The fuel/air mixture 58 then flows into the fuel conduit 54 where it mixes with additional fuel 38 from the low BTU fuel supply 14. As illustrated, the fuel rich mixture 62 then passes through a casing 64 of the compressor 24 and enters the upstream compressor stage. This process continuously repeats to enhance mixing between the fuel and air, while providing low BTU fuel to the compressor 24. As will be appreciated, because only a fraction of the fuel is extracted from the downstream stage, the remaining fuel passes through the compressor 24 and is compressed along with the air. The compressed fuel/air mixture then flows into the combustor 16 and mixes with additional fuel from the fuel nozzle 12 prior to ignition. In certain configurations, sufficient fuel is injected into the compressor 24 such that no additional fuel may be injected through the fuel nozzle 12 from a separate fuel compressor (e.g., fuel compressor 34). Such an arrangement may increase efficiency of the turbine system 10 because the fuel compressor 34 may be omitted. As a result, no additional energy may be expended to compress the low BTU fuel prior to injection, thereby increasing total power output of the turbine system 10. In embodiments where fuel is provided to the combustor 16 by the fuel compressor 34, it will be appreciated that injection of fuel into the compressor 24 may facilitate a reduction in size and/or power consumption of the compressor 34, thereby increasing efficiency of the turbine system 10. As previously discussed, providing fuel into the compressor 24 may also substantially reduce or eliminate air extraction typically associated with combustion of low BTU fuels.

Furthermore, mixing the fuel/air mixture within the compressor 24 and/or mixing device 60 may reduce emissions of various regulated exhaust products, such as oxides of nitrogen (NOx), oxides of sulfur (SOx) and/or carbon monoxide (CO), among other exhaust emissions, due to improved fuel/air distribution. The enhanced mixing may also increase the efficiency of the turbine system 10 compared to configurations in which the fuel and air are mixed solely within the combustor 16 and/or fuel nozzle 12. As will be appreciated, improved mixing may increase the quantity of fuel that reacts with the air during the combustion process, thereby enhancing the release of energy from the fuel. Moreover, improved fuel/air mixing may substantially reduce or eliminate unburned fuel from exiting the turbine system 10.

In addition, because the fuel mixture is injected downstream from the compressor inlet 41, the circulating air flow from the vanes 44 and blades 46 may serve to distribute the fuel evenly within the compressor 24. As will be appreciated, configurations in which the fuel is injected through the turbine inlet 41 may experience auto-ignition, or ignition of the fuel/air mixture within the compressor 24, at high fuel flow rates. Specifically, when a particular concentration of fuel and air is exposed to a heat source, the fuel/air mixture may ignite. To prevent the fuel from igniting within the compressor 24 due to the heat associated with compressing air, the concentration of the fuel may be limited to a level below the auto-ignition point. In embodiments in which the fuel is injected through the compressor inlet 41, local regions of high fuel concentration may be established due to ineffective mixing of the fuel and air. Consequently, the overall fuel concentration may be limited to less than approximately 20%. In contrast, due to the enhanced mixing associated with injecting the fuel downstream from the compressor inlet 41, the overall fuel concentration may be at least approximately 25% to 50%, 30% to 45%, 35% to 40%, or about 35% in the present embodiment. Specifically, the enhanced mixing may reduce the possibility of forming local regions having a fuel concentration above the auto-ignition limit. Because a larger quantity of fuel may be injected into the compressor 24, less fuel may be compressed in the fuel compressor 34, thereby increasing efficiency of the turbine system 10. In addition, the larger fuel flow rate through the compressor 24 may facilitate decreased air extraction, thereby further increasing turbine system efficiency.

While the fuel conduit 54 is positioned to inject fuel between the first stage vane 44 and the first stage blade 46 in the present embodiment, alternative embodiments may include fuel conduits 54 configured to inject fuel within other regions of the compressor 24. For example, the fuel may be injected upstream of the first stage vane 44 and/or downstream from the first stage blade 46. Furthermore, the fuel may be injected within any one or more downstream compressor stages, such as stages 1, 2, 3, 4, 5, 6, 7, 8, 9, 10, and so forth. However, regardless of where the fuel is injected, the recirculation assembly 40 may extract a fuel/air mixture from a downstream stage and reinject the fuel/air mixture into an upstream stage. In certain embodiments, the stage where the fuel is initially injected does not correspond to the stage where the fuel/air mixture is reinjected. For example, in one embodiment, the fuel may be injected into the first stage, the fuel/air mixture may be extracted from the third stage, and the fuel/air mixture may be reinjected into the second stage. Such a configuration may provide enhanced mixing of the fuel and air.

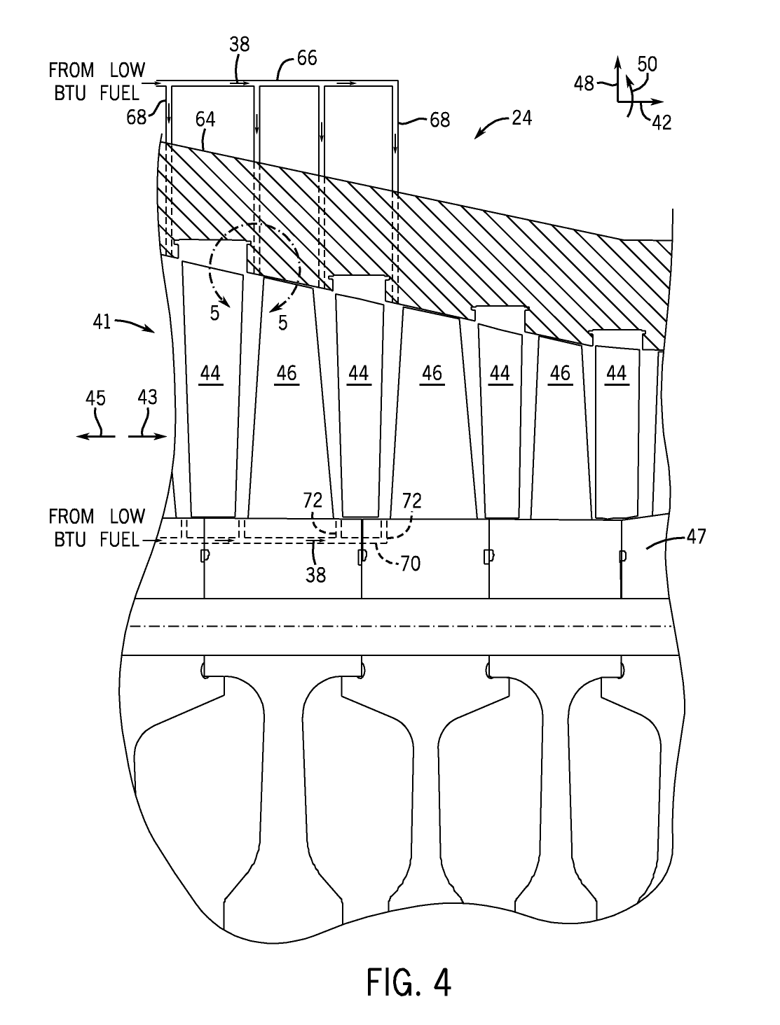

FIG. 4 is a cutaway side view of the compressor section, taken within line 3-3 of FIG. 2, illustrating gaseous fuel injection through the compressor casing 64 and the compressor hub 47. As illustrated, low BTU fuel 38 flows from a manifold 66 to individual conduits 68 extending within the compressor casing 64. In the present configuration, a first conduit 68 extends to a region upstream (i.e., along the upstream direction 45) from the first stage vane 44, a second conduit 68 extends to a region between the first stage vane 44 and the first stage blade 46, a third conduit 68 extends to a region between the first stage blade 46 and the second stage vane 44, and a fourth conduit 68 extends to a region between the second stage vane 44 and the second stage blade 46. As will be appreciated, more or fewer conduits 68 may be employed in alternative embodiments. For example, certain embodiments may include 1, 2, 3, 4, 5, 6, 7, 8, 9, 10, 11, 12, or more conduits 68 extending to various regions along the axial direction 42. Furthermore, conduits 68 may extend about the compressor 24 along the circumferential direction 50. For example, 1, 2, 3, 4, 5, 6, 7, 8, 9, 10, 11, 12, or more conduits 68 may be disposed about the circumference of the compressor 24 at each axial location. In addition, while the conduits 68 extend to regions between the vanes 44 and blades 46 in the present embodiment, alternative embodiments may include conduits 68 that intersect the casing interior at the approximate position of a vane 44 or blade 46.

The present embodiment also facilitates gaseous fuel injection through the compressor hub 47. Similar to injection through the casing 64, gaseous low BTU fuel passes through a manifold 70 to multiple conduits 72 positioned along the axial direction 42 of the compressor 24. As illustrated, a first conduit 72 extends to a region upstream (i.e., along the upstream direction 45) of the first stage vane 44, a second conduit 72 extends to a region between the first stage vane 44 and the first stage blade 46, a third conduit 72 extends to a region between the first stage blade 46 and the second stage vane 44, and a fourth conduit 72 extends to a region between the second stage vane 44 and the second stage blade 46. As will be appreciated, more or fewer conduits 72 may be employed in alternative embodiments. For example, certain embodiments may include 1, 2, 3, 4, 5, 6, 7, 8, 9, 10, 11, 12, or more conduits 72 extending to various regions along the axial direction 42. Furthermore, conduits 72 may extend about the compressor 24 along the circumferential direction 50. For example, 1, 2, 3, 4, 5, 6, 7, 8, 9, 10, 11, 12, or more conduits 72 may be disposed about the circumference of the compressor 24 at each axial location. In addition, while the conduits 72 extend to regions between the vanes 44 and blades 46 in the present embodiment, alternative embodiments may include conduits 72 that intersect the casing interior at the approximate position of a vane 44 or blade 46. Furthermore, it will be appreciated that the path of the manifold 70 and conduits 72 through the compressor 24 may vary based on compressor configuration. As will be appreciated, compressors 24 include a variety of moving parts. The path of the manifold 70 and conduits 72 may be selected to avoid such moving parts such that the manifold 70 and conduits 72 do not interfere with the operation of the compressor 24.

Furthermore, certain embodiments may be configured to inject gaseous low BTU fuel from both the hub 47 and casing 64, while other embodiments may only inject fuel through the hub 47 or casing 64. In either configuration, the gaseous fuel is injected downstream (i.e., along the downstream direction 43) from the compressor inlet 41. As previously discussed, injection of the low BTU fuel downstream from the compressor inlet 41 may facilitate enhanced mixing of the fuel and air, thereby substantially reducing or eliminating local regions of high fuel concentration that may result in auto-ignition. In this manner, larger quantities of fuel may be injected into the compressor 24 compared to configurations in which the fuel is injected through the compressor inlet 41. Furthermore, the enhanced mixing may decrease emissions of regulated exhaust products, and may improve turbine system efficiency.

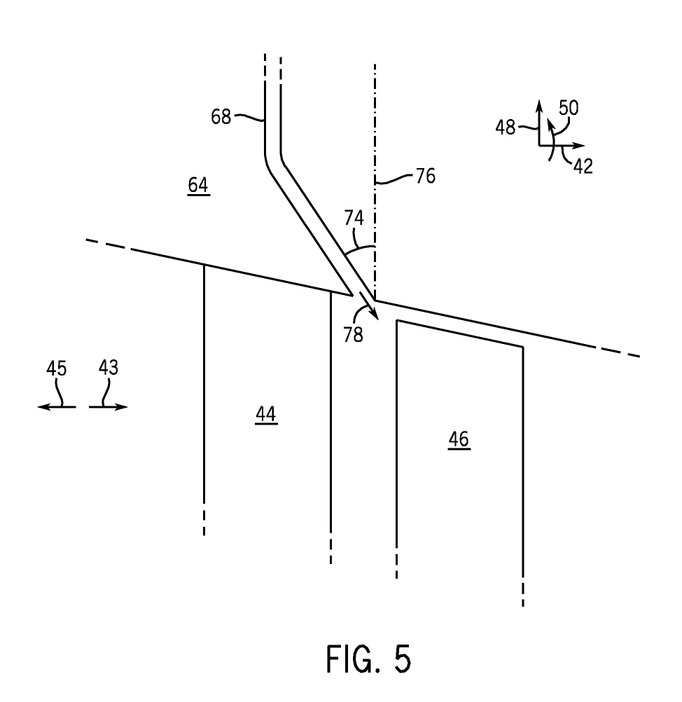

FIG. 5 is a cutaway side view of the compressor casing 64, taken within line 5-5 of FIG. 4. As illustrated, the conduit 68 is angled relative to the inner surface of the compressor casing 64. Specifically, the conduit 68 forms an angle 74 with respect to a line 76 extending along the radial direction 48. In this configuration, gaseous low BTU fuel 78 may be injected along the axial direction 42 and the radial direction 48. As will be appreciated, the angle 74 may be selected based on the compressor configuration and fuel composition, among other factors. For example, in certain embodiments the angle 74 may be approximately between 0 to 90, 10 to 80, 20 to 70, 30 to 60, 40 to 50, or about 45 degrees. In further embodiments, the conduit 68 may be angled toward the upstream direction 45 such that the air flow in the downstream direction 43 impinges upon the fuel flow. Such a configuration may facilitate enhanced mixing of the fuel and air. Furthermore, alternative configurations may angle the conduit 68 in the circumferential direction 50 to establish a swirling flow of fuel within the compressor 24. While FIG. 5 illustrates conduits 68 within the casing 64, it will be appreciated that conduits 72 within the hub 47 may also be similarly angled in the axial direction 42, radial direction 48 and/or circumferential direction 50. Such configurations may facilitate enhanced mixing of the fuel and air, thereby reducing emissions and increasing efficiency of the gas turbine system 10. In addition, the additional mixing may facilitate increased fuel flow into the compressor 24, thereby substantially reducing or eliminating the load on the fuel compressor 34 and substantially reducing or eliminating air extraction from the compressor 24.

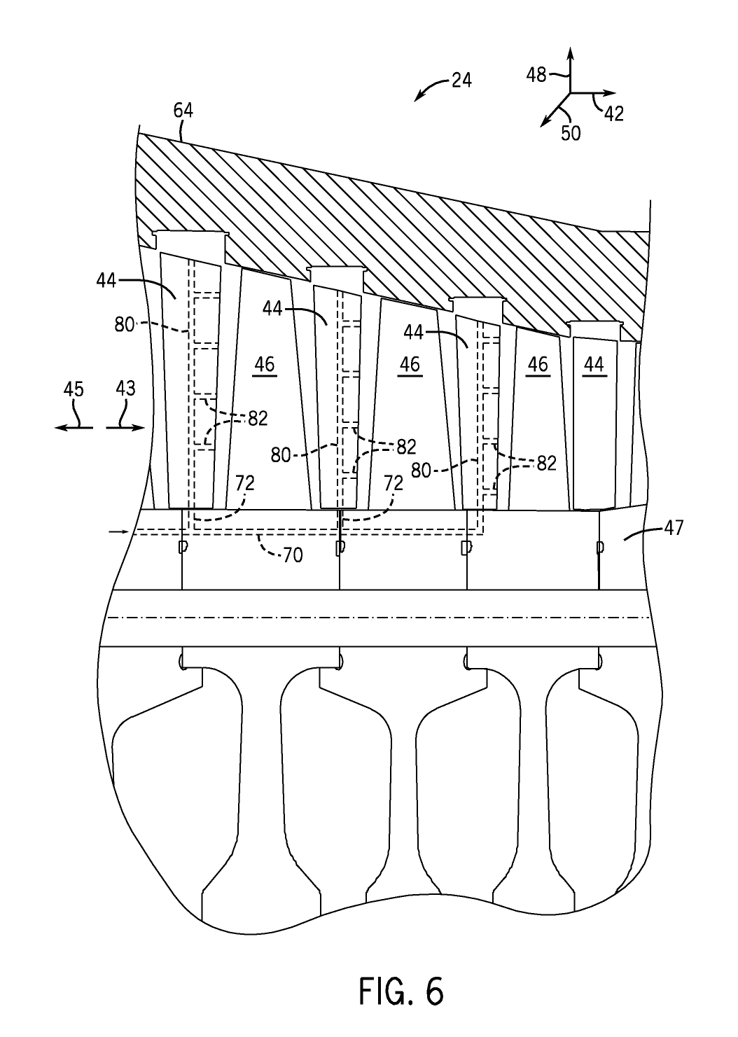

FIG. 6 is a cutaway side view of the compressor section, taken within line 3-3 of FIG. 2, illustrating gaseous fuel injection through stationary compressor vanes 44. As illustrated, the present embodiment includes a fuel manifold 70 and conduits 72 similar to the configuration described above with regard to FIG. 4. However, instead of injecting fuel directly into the compressor 24, the conduits 72 extend to manifolds 80 within the compressor vanes 44 or other radial protrusions extending into the compressor 24. Passages 82 within the vanes 44 extend from the manifold 80 to a downstream side of the vanes 44, thereby facilitating a flow of gaseous low BTU fuel into the compressor 24. As illustrated, vanes 44 of the first three compressor stages are configured to inject fuel into the compressor 24. In alternative configurations, only the first stage vane 44 and/or the second stage vane 44 may be configured to inject fuel into the compressor 24. In further embodiments, downstream vanes 44 may be configured to inject fuel into the compressor 24. Furthermore, in alternative embodiments, fuel may be provided to the vanes 44 or other radial protrusions by a manifold 66 and conduits 68 passing through the casing 64. In yet further embodiments, fuel may be provided to the vanes 44 by passages 68 extending through the casing 64 and passages 72 extending through the hub 47.

While the passages 82 extend in the axial direction 42 in the illustrated embodiment, alternative embodiments may employ passages 82 extending in the radial direction 48 and/or the circumferential direction 50. Furthermore, as discussed in detail below, more or fewer passages 82 may be present within each vane 44. In addition, the shape of the vane 44 configured to inject fuel into the compressor 24 may vary from conventional vane designs. For example, the vanes 44 may be wider than conventional configurations to accommodate the manifold 80 and passages 82. As previously discussed, the vanes 44 are disposed about the compressor 24 in a circumferential arrangement. The number of vanes 44 may be selected based on the diameter of the compressor 24 and the capacity of the compressor 24, among other factors. In the present embodiment, only a fraction of the vanes 44 may contain the manifold 80 and passages 82. For example, 2, 4, 6, 8, 10, 12, 14, or more vanes 44 may be configured to inject fuel into the compressor 24. In alternative embodiments, each vane 44 may include the manifold 80 and passages 82 for fuel injection into the compressor 24.

In further embodiments, certain vanes 44 may be replaced with other radial protrusions configured to inject fuel into the compressor 24. For example, 2, 4, 6, 8, 10, 12, 14, or more individual vanes 44 may be replaced with radial protrusions disposed about the compressor 24 along the circumferential direction 50. In certain configurations, the protrusions may be evenly spaced about the circumference to provide a uniform distribution of fuel to the compressor 24. The shape of the protrusions may be selected to both accommodate the manifold 80 and passages 82, and reduce air resistance. For example, the protrusions may be airfoil shaped, cylindrical, elliptical, or otherwise configured to limit drag, thereby providing for efficient operation of the compressor 24.

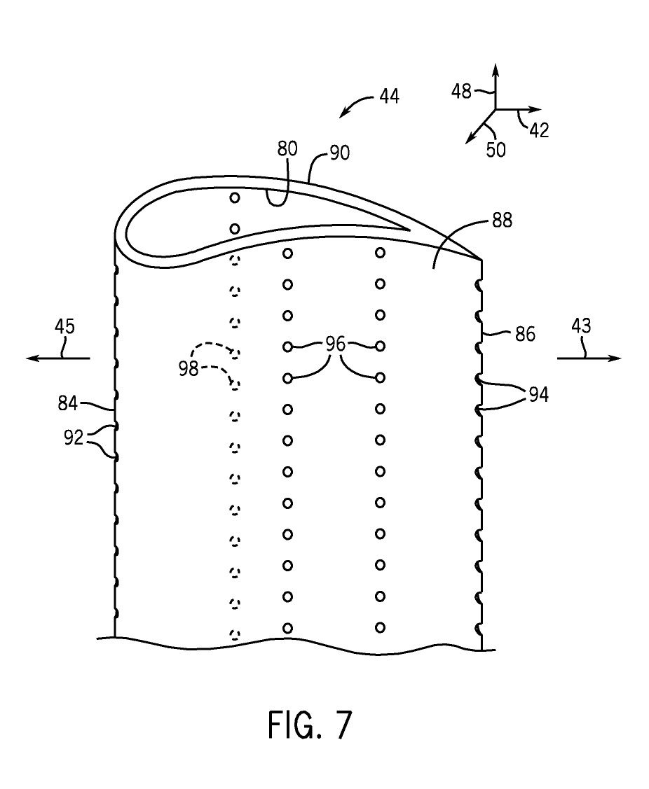

FIG. 7 is a perspective view of an exemplary stationary compressor vane 44 including multiple gaseous fuel injection orifices. As will be appreciated, each vane 44 includes a leading edge 84 disposed at an upstream end (i.e., along the upstream direction 45), a trailing edge 86 disposed at a downstream end (i.e., along the downstream direction 43), a pressure surface 88 and a suction surface 90. In the present embodiment, gas injection orifices 92 are disposed on the leading edge 84, gas injection orifices 94 are disposed on the trailing edge 86, gas injection orifices 96 are disposed on the pressure surface 88, and gas injection orifices 98 are disposed on the suction surface 90. In operation, gaseous low BTU fuel may enter the vane 44 through the manifold 80, flow through a passage 82, and exit an associated orifice 92, 94, 96 or 98. Certain embodiments may only include orifices on the leading edge 84, the trailing edge 86, the pressure surface 88, or the suction surface 90. Further embodiments may include orifices on any combination of the above-described surfaces. For example, certain embodiments may include orifices 96 on the pressure surface 88, orifices 94 on the trailing edge 86, and orifices 98 on the suction surface 90.

Furthermore, the number of orifices on each surface may vary in alternative configurations. For example, while the pressure surface 88 includes two columns of orifices 96 extending along the radial direction 48, alternative embodiments may include more or fewer columns. For example, certain embodiments may include 1, 2, 3, 4, 5, 6, 7, 8, or more columns of orifices 96. In further embodiments, the orifices 96 may be arranged in alternative configurations, such as rows, concentric circles, a spiral pattern, or a random pattern, among other configurations. As will be appreciated, the size of the orifices 96 may be particularly selected to achieve a desired flow rate and flow velocity of fuel into the compressor 24. Similarly, the total number of orifices 96 may be selected to provide a desired fuel flow rate and evenly distribute the fuel flow throughout the compressor 24. Furthermore, while one column of orifices 98 is disposed on the suction surface 90, alternative embodiments may employ orifice configurations similar to those described with reference to the pressure surface 88. In addition, the number and size of the orifices 92 on the leading edge 84 and the orifices 94 on the trailing edge 86 may be selected to provide a suitable flow and distribution of gaseous low BTU fuel into the compressor 24.

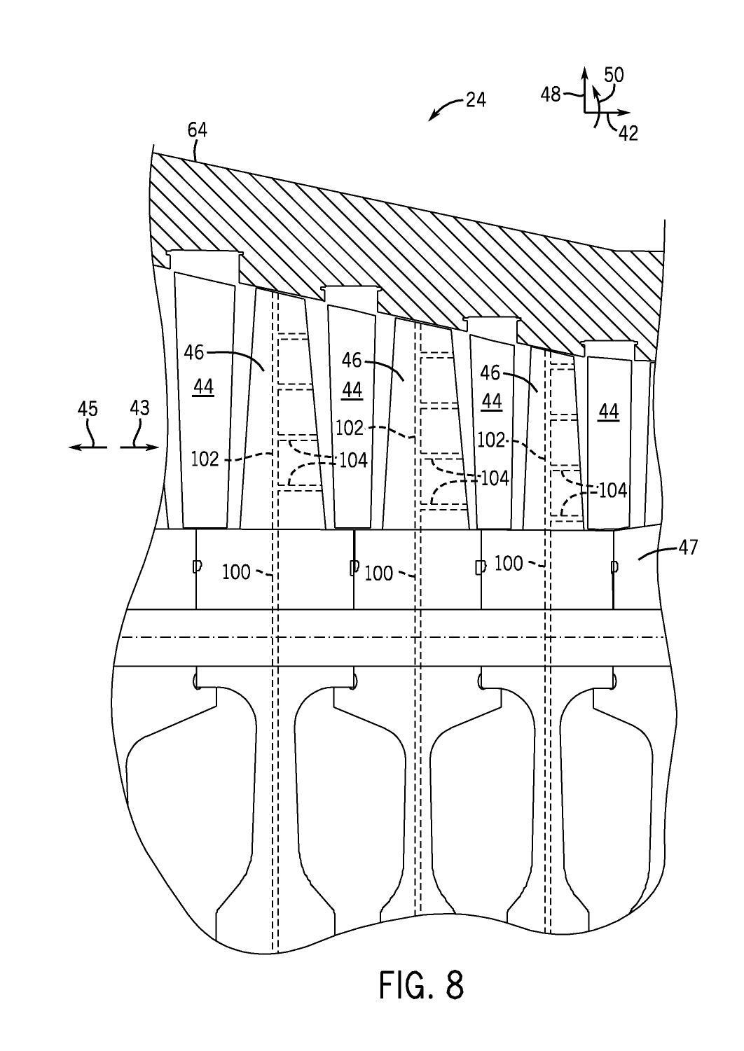

FIG. 8 is a cutaway side view of the compressor section, taken within line 3-3 of FIG. 2, illustrating gaseous fuel injection through rotating compressor blades 46. As will be appreciated, because the compressor blades 46 are configured to rotate within the compressor 24, the fuel delivery system may be configured to accommodate such rotation. Specifically, fuel conduits 100 may extend from the shaft and rotate as the blades 46 are driven to rotate. For example, in certain configurations, fuel may be fed through a passage within the shaft to the conduits 100 which are rigidly coupled to the shaft. The conduits 100 may then convey the low BTU gaseous fuel to a manifold 102 within each blade 46. The manifolds 102, in turn, deliver the fuel to passages 104 within the blades 46. In this manner, low BTU gaseous fuel may be injected into the compressor 24 through the blades 46 despite rotation of the blades 46. As illustrated, blades 46 of the first three compressor stages are configured to inject fuel into the compressor 24. In alternative configurations, only the first stage blade 46 and/or the second stage blade 46 may be configured to inject fuel into the compressor 24. In further embodiments, downstream blades 46 may be configured to inject fuel into the compressor 24.

While the passages 104 extend in the axial direction 42 in the illustrated embodiment, alternative embodiments may employ passages 104 extending in the radial direction 48 and/or the circumferential direction 50. Furthermore, as discussed in detail below, more or fewer passages 104 may be present within each blade 46. In addition, the shape of the blade 46 configured to inject fuel into the compressor 24 may vary from conventional blade designs. For example, the blades 46 may be wider than conventional configurations to accommodate the manifold 102 and passages 104. As previously discussed, the blades 46 are disposed about the compressor 24 in a circumferential arrangement. The number of blades 46 may be selected based on the diameter of the compressor 24 and the capacity of the compressor 24, among other factors. In the present embodiment, only a fraction of the blades 46 may contain the manifold 102 and passages 104. For example, 2, 4, 6, 8, 10, 12, 14, or more blades 46 may be configured to inject fuel into the compressor 24. In alternative embodiments, each blade 46 may include the manifold 102 and passages 104 for fuel injection into the compressor 24.

In further embodiments, the blades 46 may be replaced with other radial protrusions configured to inject fuel into the compressor 24. For example, 2, 4, 6, 8, 10, 12, 14, or more individual blades 46 may be replaced with radial protrusions disposed about the compressor 24 along the circumferential direction 50. In certain configurations, the protrusions may be evenly spaced about the circumference to provide a uniform distribution of fuel to the compressor 24. The shape of the protrusions may be selected to both accommodate the manifold 102 and passages 104, and reduce air resistance. For example, the protrusions may be airfoil shaped, cylindrical, elliptical, or otherwise configured to limit drag, thereby providing for efficient operation of the compressor 24. As will be appreciated, the rotating protrusions or blades 46 may provide enhanced mixing compared to injection through stationary protrusion or vanes 44. Specifically, the rotating motion of the fuel injection orifices may serve to more evenly distribute the fuel within the compressor 24. As previously discussed, the enhanced mixing may facilitate decreased turbine system emissions, improved efficiency and increased fuel injection into the compressor 24. Therefore, embodiments including fuel injection through the blades 46 may be employed despite the additional complexity associated with routing fuel to rotating parts.

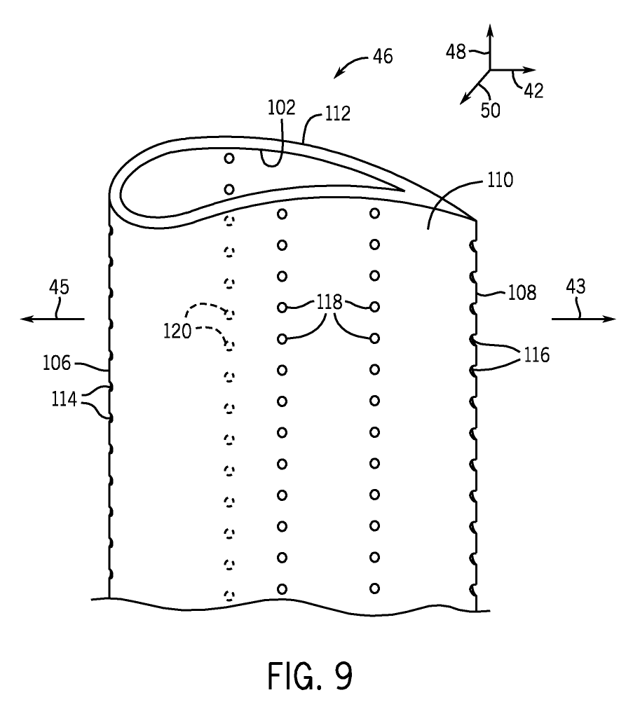

FIG. 9 is a perspective view of an exemplary rotating compressor blade 46 including multiple gaseous fuel injection orifices. Similar to the vanes 44, each blade 46 includes a leading edge 106 disposed at an upstream end (i.e., along the upstream direction 45), a trailing edge 108 disposed at a downstream end (i.e., along the downstream direction 43), a pressure surface 110 and a suction surface 112. In the present embodiment, gas injection orifices 114 are disposed on the leading edge 106, gas injection orifices 116 are disposed on the trailing edge 108, gas injection orifices 118 are disposed on the pressure surface 110, and gas injection orifices 120 are disposed on the suction surface 112. In operation, gaseous low BTU fuel may enter the blade 46 through the manifold 102, flow through a passage 104, and exit an associated orifice 114, 116, 118 or 120. Certain embodiments may only include orifices on the leading edge 106, the trailing edge 108, the pressure surface 110, or the suction surface 112. Further embodiments may include orifices on any combination of the above-described surfaces. For example, certain embodiments may include orifices 118 on the pressure surface 110, orifices 116 on the trailing edge 108, and orifices 120 on the suction surface 112.

Furthermore, the number of orifices on each surface may vary in alternative configurations. For example, while the pressure surface 110 includes two columns of orifices 118 extending along the radial direction 48, alternative embodiments may include more or fewer columns. For example, certain embodiments may include 1, 2, 3, 4, 5, 6, 7, 8, or more columns of orifices 118. In further embodiments, the orifices 118 may be arranged in alternative configurations, such as rows, concentric circles, a spiral pattern, or a random pattern, among other configurations. As will be appreciated, the size of the orifices 118 may be particularly selected to achieve a desired flow rate and flow velocity of fuel into the compressor 24. Similarly, the total number of orifices 118 may be selected to provide a desired fuel flow rate and evenly distribute the fuel flow throughout the compressor 24. Furthermore, while one column of orifices 120 is disposed on the suction surface 112, alternative embodiments may employ orifice configurations similar to those described with reference to the pressure surface 110. In addition, the number and size of the orifices 114 on the leading edge 106 and the orifices 116 on the trailing edge 108 may be selected to provide a suitable flow and distribution of gaseous low BTU fuel into the compressor 24.

Further embodiments may employ a combination of various fuel injection configurations. For example, certain embodiments may employ both vanes 44 and blades 46 configured to inject fuel into the compressor 24. By further example, certain embodiments may include fuel injection assemblies configured to inject fuel through the hub 47, the casing 64, vanes 44, blades 46, stationary radial protrusions, rotating radial protrusions, or any combination thereof. The particular arrangement may be selected to facilitate enhanced mixing of fuel and air within the compressor 24, thereby decreasing emissions of regulated exhaust products, improving turbine system efficiency, and substantially reducing or eliminating the possibility of auto-ignition within the compressor 24. Regardless of the particular arrangement, injecting gaseous low BTU fuel within the compressor may substantially reduce or eliminate power draw by the fuel compressor 34, and may substantially reduce or eliminate air extraction from the compressor 24, thereby increasing the overall efficiency of the turbine system 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a gas turbine compressor comprising an upstream stage and a downstream stage; and
a gaseous fuel recirculation assembly in fluid communication with the upstream stage and the downstream stage, wherein the gaseous fuel recirculation assembly is configured to inject gaseous fuel into the upstream stage, extract a fuel/air mixture from the downstream stage, and reinject the fuel/air mixture into the upstream stage.

2. The system of claim 1, wherein the gaseous fuel recirculation assembly comprises a mixing device outside of the gas turbine compressor to mix the fuel/air mixture prior to reinjection into the upstream stage.

3. The system of claim 1, wherein the gaseous fuel comprises a low British Thermal Unit (BTU) fuel having a lower heating value (LHV) of approximately between 50 to 400 BTU per standard cubic foot (scf).

4. The system of claim 1, wherein the upstream stage comprises a plurality of stationary vanes each including a plurality of gaseous fuel injection orifices, wherein each stationary vane is in fluid communication with the gaseous fuel recirculation assembly, and each stationary vane is configured to inject gaseous fuel, the fuel/air mixture, or a combination thereof, into the upstream stage.

5. The system of claim 1, wherein the upstream stage comprises a plurality of rotating blades each including a plurality of gaseous fuel injection orifices, wherein each rotating blade is in fluid communication with the gaseous fuel recirculation assembly, and each rotating blade is configured to inject gaseous fuel, the fuel/air mixture, or a combination thereof, into the upstream stage.

6. The system of claim 1, wherein the gas turbine compressor comprises a casing disposed about the upstream stage and the downstream stage, wherein the casing includes a plurality of gaseous fuel injection orifices each in fluid communication with the gaseous fuel recirculation assembly, and each orifice is configured to inject gaseous fuel, the fuel/air mixture, or a combination thereof, into the upstream stage.

7. The system of claim 1, wherein the gas turbine compressor comprises a hub coupled to the upstream stage and the downstream stage, wherein the hub includes a plurality of gaseous fuel injection orifices each in fluid communication with the gaseous fuel recirculation assembly, and each orifice is configured to inject gaseous fuel, the fuel/air mixture, or a combination thereof, into the upstream stage.

8. The system of claim 1, comprising a gaseous fuel pump in fluid communication with the gaseous fuel recirculation assembly, wherein the gaseous fuel pump is configured to provide gaseous fuel to the gaseous fuel recirculation assembly at a pressure greater than a pressure within the upstream stage of the gas turbine compressor.

9. The system of claim 1, comprising a gas turbine engine including the gas turbine compressor.

10. A system comprising:
a gas turbine compressor comprising a plurality of radial protrusions disposed about a circumference of the gas turbine compressor, wherein each radial protrusion includes a plurality of gaseous fuel injection orifices configured to inject gaseous fuel into the gas turbine compressor.

11. The system of claim 10, wherein the gaseous fuel comprises a low British Thermal Unit (BTU) fuel having a lower heating value (LHV) of approximately between 50 to 400 BTU per standard cubic foot (scf).

12. The system of claim 10, wherein at least a portion of the plurality of radial protrusions comprises stationary vanes.

13. The system of claim 12, wherein the plurality of gaseous fuel injection orifices is disposed on a leading edge, a trailing edge, a pressure surface, a suction surface, or a combination thereof, of the stationary vanes.

14. The system of claim 10, wherein at least a portion of the plurality of radial protrusions comprises rotating blades.

15. The system of claim 14, wherein the plurality of gaseous fuel injection orifices is disposed on a leading edge, a trailing edge, a pressure surface, a suction surface, or a combination thereof, of the rotating blades.

16. A system comprising:
a gas turbine compressor comprising an air inlet disposed at an upstream end of the gas turbine compressor; and
a plurality of gaseous fuel injection orifices disposed within the gas turbine compressor downstream from the air inlet, wherein each gaseous fuel injection orifice is configured to inject gaseous fuel into the gas turbine compressor.

17. The system of claim 16, wherein at least a portion of the plurality of gaseous fuel injection orifices is disposed within a plurality of stationary vanes disposed about a circumference of the gas turbine compressor.

18. The system of claim 16, wherein at least a portion of the plurality of gaseous fuel injection orifices is disposed within a plurality of rotating blades disposed about a circumference of the gas turbine compressor.

19. The system of claim 16, wherein at least a portion of the plurality of gaseous fuel injection orifices is disposed within a hub extending axially through the gas turbine compressor, within a casing disposed about the gas turbine compressor, or a combination thereof.

20. The system of claim 16, wherein the gaseous fuel comprises a low British Thermal Unit (BTU) fuel having a lower heating value (LHV) of approximately between 50 to 400 BTU per standard cubic foot (scf).
